(19) United States
(12) Patent Application Publication
(10) Pub. No.: US 2007/0106420 A1
(43) Pub. Date: May 10, 2007

(54) COMPUTER-BASED INTEGRATION OF ALL OPERATING PROCEDURES IN PRODUCTION MACHINES

(75) Inventor: ARNO WYRWOLL, Munchen (DE)

Correspondence Address: Henry M. Feiereisen;Henry M. Feiereisen, LLC, Suite 4714, 350 Fifth Avenue, New York, NY, 10118, US

(73) Assignee: Krauss-Maffei Kunststofftechnik GmbH, Munchen (DE)

(21) Appl. No.: 11/615,346

(22) Filed: Dec. 22, 2006

Related U.S. Application Data
(63) Continuation of application No. PCT/EP05/54066, filed on Aug. 18, 2005.

(30) Foreign Application Priority Data
Aug. 31, 2004 (DE) 10 2004 041 891.8

(51) Int. Cl. G06F 19/00

(52) U.S. Cl. 700/200; 700/196; 700/106; 700/97

(57) ABSTRACT

Apparatus for processing plastics, particularly an extrusion machine or injection molding machine, includes a material supply device, a plasticizing device and a molding device which are controlled by a control device to allow plastic products to be produced in a fully automated manner while taking into account essential operational processes. The apparatus includes first recording means which record the raw material supply and/or changes in the raw material supply, second recording means which records process parameters and/or material parameters, and a control device with evaluation means which determine from the data of the first and second recording means the expected raw material consumption, the expected production time, and/or the expected production cost for a given quantity of the product. Several apparatuses of this type can be combined in a single machine unit and controlled by the control device of one apparatus operating as a master.

### CROSS-REFERENCES TO RELATED APPLICATIONS

This application is a continuation of prior filed copending PCT International application no. PCT/EP2005/054066, filed Aug. 18, 2005, which designated the United States and has been published but not in English as International Publication No. WO 2006/024606 and on which priority is claimed under 35 U.S.C. §120, and which claims the priority of German Patent Application, Serial No. 10 2004 041 891.8, filed Aug. 31, 2004, pursuant to 35 U.S.C. 119(a)-(d), the contents of which are incorporated herein by reference in its entirety as if fully set forth herein.

### BACKGROUND OF THE INVENTION

The present invention is directed to a production machine, e.g. an apparatus for processing plastic materials. In particular, the present invention is directed to a production machine or an apparatus for processing plastic materials, which allows an essentially fully automatic production of plastic products by taking into account important operating procedures.

Nothing in the following discussion of the state of the art is to be construed as an admission of prior art.

Conventional devices for processing plastic material, for example extrusion machines or injection molding machines, typically include control devices which control the manufacture of plastic products in a continuous and/or recurring process. Such control devices are typically constructed so that during the manufacture of a plastic product both production and machine state parameters are, on one hand, read out in a very limited fashion and, on the other hand, at least an evaluation of this information occurs in very large time intervals, for example during a product change or the like. Conventional control devices for devices that process plastic materials (plastic processing machines) frequently offer only very limited opportunities to modify the machine state or processing parameters during the production, which is typically possible only directly at the installation site of the corresponding plastic processing machine.

It is generally a problem that conventional control devices for plastic processing machines are capable of communicating with production planning and control systems (PPS systems) or with operating data acquisition systems (BDE systems), such as SAP or the like, only in a limited way and often complex manner due to a lack of interface standards. In these systems, production planning and control therefore typically starts from the PPS system, so that production planning is rather unreliable and essential parameters are frequently not taken into consideration due to the limited communication between the plastic processing machines and PPS system. Conventional PPS systems typically operate according to the PPS process which is implemented based on operational aspects, and not on the production or plastic processing machine and the produced product.

As a result, these production processes can be automated only in a limited fashion, therefore almost always necessitating a regulating or correcting human intervention in the production planning and control.

However, such conditions are undesirable in particular for contract manufacturers of plastic products using an injection molding or extrusion process.

It would therefore be desirable and advantageous to provide an improved device for processing of plastic materials, which obviates prior art shortcomings and allows in particular an essentially complete automation of the production of plastic products by taking into account important operating procedures.

### SUMMARY OF THE INVENTION

According to one aspect of the invention, an apparatus for processing plastic materials (plastic processing machine), in particular an extrusion or injection molding machine, includes at least one material supply device, at least one plasticizing unit, at least one microprocessor-controlled control device for controlling the material supply device, the plasticizing unit and/or the molding device, as well as first and second recording means. The material supply device supplies the plastic material to be processed to the plasticizing unit as raw material, which is plasticized and/or homogenized in the plasticizing unit through application of mechanical and/or thermal energy. The material plasticized and/or homogenized by the plasticizing unit is thereafter subjected in the molding device to a forming process, thereby forming a plastic product, in particular an intermediate or end product. The product is removed, in particular demolded, from the molding device after a predetermined cooling and/or hardening time and/or supplied to an additional processing step.

In the inventive apparatus, the first recording means are provided on the material supply device and connected with the control device via a connection for transmitting data. The first recording means record the raw material supply and/or the change in the material supply in the material supply device and transmit this information to the control device. The second recording means of the inventive device are provided on the molding device and/or on the plasticizing unit and are also connected with the control device via a connection for transmitting data. The second recording means are used to record process and/or material parameters of the plasticized and/or homogenized material or of the product and also transmit the process and/or material parameters to the control device.

The control device of the inventive apparatus includes evaluation means which determine from the data received from the first and/or second recording means essentially in real time the expected raw material requirements, the expected production time and/or the expected production cost for a predetermined quantity of the product or the like, as well as other information relevant for production planning and control.

According to an advantageous embodiment of the invention, the evaluation means of the control device determine from the data obtained by the second recording means essentially in real time the error probability, the error frequency and/or a quality value of the product, wherein this information is preferably taken into consideration for determining the expected raw material requirements, the expected production time and/or the expected production costs for a predetermined quantity of the product or other information relevant for production planning and control.

This allows, on one hand, continuous monitoring of the quality of the manufactured products and, on the other hand, incorporation of a change in the error frequency and/or the quality value and a possibly resulting in increased or decreased production of rejected product in the production planning and control of the respective product and/or second-generation products.

In particular, by using adaptation means, the control device automatically adapts the parameters controlling the material supply device, the plasticizing unit and/or the molding device based on the error probability, the error frequency and/or the quality value, in order to enhance the quality value of the product or to reduce the error frequency or error probability, to thereby optimize production planning and control of the corresponding product and/or second-generation products.

According to another advantageous embodiment of the invention, third recording means are provided which are used by the control device to record machine downtimes, in particular set-up times, maintenance times or the like, tool wear and tool utilization times, machine and/or tool errors, energy consumption, coolant consumption and the like. In one preferred embodiment, the information recorded by the third recording means is taken into consideration for determining the expected raw material requirements, the expected production time and/or the expected production costs for a predetermined quantity of the product or other information relevant for production planning and control.

In this way, for example, errors of the machine or the actually used tool, or set-up and maintenance times for the production planning and control of the respective products and/or on the second-generation products can be included and taken into consideration, which increases the reliability of the production planning and control with the device of the invention.

According to yet another advantageous embodiment of the invention, the control device is connected with a data network, in particular with an intranet or with the Internet, for example via a cable, glass fiber or wireless connection. The control device makes available via the data network data services which are selected from a group that includes Web server services (World Wide Web), FTP server services (File-Transfer-Protocol), SQL server services (Structured Query Language), e-mail services, application server services, such as J2EE services or .net services, file server services, such as Web-DAV (Web based distributed authoring and versioning), SMB-(Server Message Block), NFS-(Network File System) or AFP-(Apple talk filing protocol)-server services and the like.

The control device not only makes data services available in the network, but may also be used as a terminal (client) for such data services. Alternatively, a separate terminal can be provided.

Advantageously, the control device provides via the data services in the data network the information recorded and/or determined by the first, second and/or third recording means and/or by the control device, in particular the expected raw material requirements, the expected production time and/or the expected production cost for a predetermined quantity of the product, and/or other information derivable therefrom about the product, the production flow and/or the production planning.

Via the data network and the corresponding data services, which are preferably provided by data service means of the control device in the data network, data can be retrieved which can provide information about the current status of the production process of a certain product or the anticipated conclusion of the production, the precise production cost, the still required raw material requirements, and optionally information which may be relevant for ensuring quality assurance of the product. In particular, such information can be recalled via the Web or XML server service or the application server service which can be accessed via the data network, for example externally via the Internet. It is particularly advantageous, e.g., with an exemplary contract manufacturer of injection-molded products, if the customer himself can continuously obtain information via a customer-specific access about the production status of the ordered products and for example the anticipated production end or the anticipated production date and thereby the accurate availability of the products.

According to still another advantageous embodiment of the invention, the control device may include first means which preferably automatically initiate via the data network, for example via e-mail and the like, after completion of a predetermined quantity of the product or for the date of the expected completion of a predetermined quantity of the product, as determined by the evaluation means of the control device in real time, packaging, shipping and/or the preparation of invoicing documents, for example shipping documents, packing slips and invoices, such that for example at the time when the finished product is completed, a suitable product package is already ready or is made available by the shipper, so that the products can be shipped immediately after manufacture without any delay.

This approach is particularly advantageous for minimizing shipping and storage costs, because the shipper of the respective products can be informed by the device of the invention of the exact time when the product is being completed and the availability of the packaged product, thereby eliminating undesirable storage and wait times.

According to another advantageous embodiment of the invention, the control device may include second means which automatically determine or take into consideration in the production planning and control operating times, based on the information received or recorded and/or determined by the control device, downtimes and/or the like for machine retooling, maintenance and the like, and initiates the retooling or maintenance of the machine or of the tools at the corresponding date. In another preferred embodiment, the control device uses the information about error frequency and error probability, or the information about the expected completion date of the product and the like, so as to schedule dates for maintenance and service work, so that this work interferes as little as possible with the production or intervenes in the operation or production planning.

According to another advantageous embodiment of the invention, the control device may include third means which initiate, based on the information recorded by the first, second and/or third recording device and/or recorded or determined by the control device, an order or a follow-up order and delivery of raw material, which occurs in particular by taking into consideration raw material specifications, raw material delivery times or delivery schedules or availabilities. The order is preferably placed by the control device via the data network, and in a particularly preferred embodiment via the Internet.

In yet another advantageous embodiment, the control device may further include fourth means which determine via the data network raw material specifications, raw material availability, raw material price and/or the like from at least one raw material supplier, and optionally automatically select one raw material supplier from a plurality of suppliers, for example based on an advantageous raw material price, advantageous delivery conditions or improved raw material specifications. The raw material is then preferably ordered from the supplier selected from a plurality of raw material suppliers.

Preferably, the control device may also include or store information about the reliability of one or more raw material suppliers or their material quality, etc., and in particular their punctual delivery, and includes this information in the automated selection of a raw material supplier from a plurality of suppliers.

In another advantageous embodiment of the invention, the data services provided by the control device in the data network can be accessed via the data network, for example, via a data service terminal (client), and the parameters of a product manufacturing process, the predetermined quantity of a product, the raw material specifications for a product, a minimum quality value of a product, and a priority value for a product and, in particular, a target delivery date, as well as tool or machine maintenance intervals and/or the like can be changed. In this way, both the manufacturer and a customer, for example a contract manufacturer of injection molded products, is able to affect the production and in particular changed requirements regarding the production quantity, the delivery date, the production quality and certain product characteristics before and/or during the production, and in particular is able to increase or decrease the priority for producing a product, depending if an earlier or a later delivery date for the product is desired.

In particular, certain product characteristics, such as the product color, the elasticity of the plastic, etc., can be adapted to the customer specification, allowing the control device, again automatically, to initiate a corresponding change of the raw material order, preferably by taking into consideration changed material specifications, material prices and/or delivery dates from different raw material suppliers, and to incorporate these changes in the production.

It is also in the spirit of the invention that the control device may include means which, based for example on the information and/or request profiles transmitted by customers from the data service terminals (clients) via the data network to the control device and optionally preliminary delivery dates or the like, automatically generate production offers or order confirmations and optionally schedules or determines preliminary delivery dates and the like and provides these to the customer over the data network or the data services provided in the data network, and in particular the Web or XML server service, the application server service or the e-mail service. Preferably, the present device also enables ordering of products based, for example, on the production orders via the data services provided over the data network and also enables integration of additional operating processes into the production planning and control system that is implemented in the control device, wherein the production planning and control system can be accessed via the data network for communication.

In yet another advantageous embodiment of the invention, the control device may be connected with at least one input or reading device for personal data, in particular with a magnetic and/or chip card reading device or with a device for acquiring biometric data, such as fingerprints, handprints or face recognition systems, which allow authentication, login and logoff of personnel, in particular personnel involved in machine set-up or maintenance, at the corresponding plastic processing machine, for example, to perform setup and maintenance work on the plastic processing machine.

An apparatus for processing plastic materials can be provided in this manner which, except for these authentication capabilities, has no other provision for direct human intervention and may not even permit human intervention, unless the intervening person is authenticated at the machine and thereby initiates a setup and/or maintenance interval.

The plastic processing machine of the invention permits recording of personnel data and, in a broader sense, also an integration of human resource management in the control device of the inventive plastic processing machine. The control device can take this human resource information into account when evaluating the obtained information, in particular for determining the time remaining in the production of a predetermined quantity of a product or for determining the actual cost.

In another advantageous embodiment of the invention, the data received by the first, second and/or third recording means and/or the information recorded and/or determined by the control device, as well as information obtained from the data service terminals (clients) or provided by the control device via data services, may be stored in the control device and/or in a storage device connected with the control device, such as for example a hard disk storage device, a magnetic tape storage device, flash memory, EEPROM memory (Electrically Erasable Programmable Read-Only Memory), RAM memory (Random Access Memory) or the like.

This type of storage makes it possible to continuously document the operating procedure and the production process as well as possible problems and to provide on this basis quality control for each individual workpiece from the raw material to the finished product. When the information received or determined by the recording means or by the control device is stored, it becomes feasible to record over a longer period of time troubles or error sources, which had lead to an increase in the error frequency or error probability or to a reduced quality value, giving the customer himself the option to modify the production parameters in other second-generation productions for second-generation productions of an identical or of a similar product. In particular, storage of the operational information, such as production offers, orders, packing slips, invoices and other billing documents or information allows further processing of this information, for example for generating account closures and the like.

In the plastic processing machine of the invention, the entire process chain which includes material procurement, logistics, personnel, finances and controlling can be imaged in the production machine by integrating the modules material procurement, finances, logistics, controlling and personnel of a classic PPS system, so that data about process times and costs are captured closer to their origin and more exactly than with conventional PPS/BDE systems. The plastic processing machine according to the invention therefore makes it possible unexpectedly and by taking into account all relevant parameters to precisely determine the production costs (actual costs) for the production of plastic articles and to record these costs, for example, for a later evaluation.

The present invention also relates to a machine unit, whereby the control devices of at least two devices for processing plastic materials, in particular extrusion or injection molding machines, are connected with each other via a data network, in particular via an intranet or via the Internet, with the control device of a first apparatus for processing plastic materials operating as a central control device (master) for the control devices of additional devices for processing plastic materials (slaves), wherein the information recorded by the first, second and/or third recording means of all apparatuses for processing plastic materials and/or the information recorded and/or determined by the control devices of the slaves are transmitted to the master, and wherein the master combines, in particular settles, the information recorded and/or determined by the master and/or the information received from the slaves, and determines therefrom for the machine unit essentially in real time the expected raw material requirements, the expected production time and/or the expected actual costs for a predetermined quantity of the product or the like.

The term machine unit in the context of the present invention refers to at least two apparatuses for processing plastic materials which are installed at the same site or at different sites.

According to another advantageous embodiment of the machine unit according to the invention, the master includes two adaptation means which are used to control via the data network the parameters of the product or the production process, the predetermined quantity of the product, the raw material requirements for the product, a minimum quality value for the product, the tool or machine maintenance intervals and/or the like of the slaves or of the devices for processing plastic materials associated with the slaves.

A machine unit according to the present invention allows essentially an automatic control of the production planning and control of a plurality of apparatuses for processing plastic materials by using a central control device. In this way, plastic processing apparatuses can be used at different sites, for example, to produce exactly an identical product upon demand and particularly if a plastic processing machine at one site breaks down, to replace the production capacity of the broken machine with another plastic processing apparatus of the machine unit, or to compensate by correspondingly extending the production time of other plastic processing machines of the machine unit.

The machine unit according to the invention allows, in particular, to also implement central production planning and control processes with the master, whereas the corresponding slaves coordinate, for example, inventory of the raw material is determined and stored and/or placing orders and delivery according to the production planning and control of the master. In particular, the production parameters of individual slaves can also be adapted so that, for example, only some plastic processing devices of the machine unit produce products with changed production characteristics, such as a changed product color or a changed error frequency or probability, in which case the products are modified by changes in the corresponding production parameters, whereas the other plastic processing apparatuses of the machine unit continue to produce products with the originally specified product parameters or based on the originally specified product quantity.

Preferably, a data service terminal (client) communicates with the master of the machine unit, so that for example a customer of a contract manufacturer of injection-molded products or the manufacturer himself can increase or reduce the quantity of the product to be produced during the production or can define or adjust the priority and/or delivery time schedules for a production, whereby the production or production parameters of the slaves are automatically adapted by the master as needed, thereby changing the production accordingly. In particular, because the production parameters or the estimated remaining time for the production of a predetermined quantity of a product are determined essentially in real time, the end user (client) accessing the data services of the master or of a control device of the plastic processing apparatus receives updated information at same time the changed production parameters, product quantities and the like are inputted, regarding the effects on the remaining production time, the product quality, the production costs and the expected raw material requirements.

The present invention also contemplates to implement the functions of a single plastic processing machine described in conjunction with an apparatus according to the invention for processing plastic materials in the context of a machine unit according to the invention, thus enabling centralized and essentially automated production planning and control in the form of a dialogue with the customer via the data network and the data services provided by the control device and the master, as well as without necessitating intervention by the manufacturer.

The apparatus for processing plastic materials and the machine unit according to the present invention makes it possible to realize a fully automatic production of plastic articles, wherein human intervention is required only in the event of retooling or maintenance. Maintaining raw material inventory as well as packaging and shipping, producing shipping documents and invoices are performed fully automatically by the control device of a device according to the invention and/or by the master of a machine unit according to the present invention and do not require additional intervention from the machine operator or the manufacturer.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic diagram of an apparatus according to the invention for processing plastic materials;

FIG. 2 is a schematic diagram of a machine unit according to the present invention.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

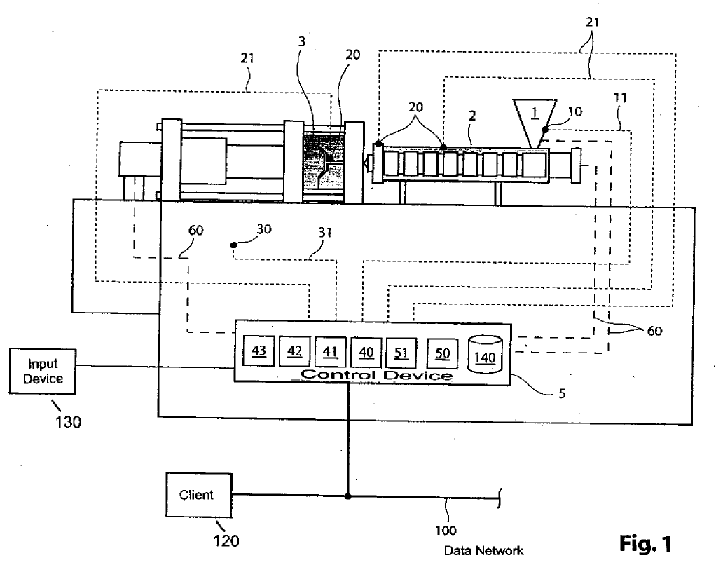

Turning now to the drawing, and in particular to FIG. 1, there is shown an injection molding machine according to the invention with a material supply device 1 which supplies the raw material to be processed to a plasticizing unit 2. It should be pointed out, however, that although the described features and functions are described with reference to an exemplary injection molding machine, they may likewise apply also to extrusion machines and other plastic processing machines. The production machine according to the invention further includes a molding device 3 in form of an injection mold, into which the material that is plasticized and homogenized by the plasticizing unit is injected under pressure when the mold is closed, and from which the workpiece is demolded after a predetermined cooling or hardening time by opening the injection mold. The machine further includes a control device 5 which is connected via control lines 60 with the plasticizing unit 2, the material supply device 1 and the molding device 3, and in particular with the actuation mechanism for opening/closing the injection mold. The control commands of the control device 5 are transmitted via the control lines 60 to the corresponding components.

As shown in FIG. 1, the injection molding machine according to the invention also includes first recording means 10 disposed at the material supply device 1 and connected with the control device 5 via the connecting line 11 for transmitting data in such a way that information concerning the raw material supply or the change of the raw material supply, in particular as a function of time, is transmitted from the first recording means 10 to the control device 5.

The illustrated injection molding machine includes second recording means 20 disposed at the plasticizing unit 2 and, in particular, at its nozzle as well as on the injection mold itself, wherein the second recording means 20 are connected with the control device 5 via a connecting lines 21 for data transmission to transmit to the control device 5 information about the plasticized and homogenized material or about material that remains in the injection mold after injection molding. This information includes, in particular, information about the state of the material, for example material temperature, material viscosity, material homogeneity, material pressure or the like.

The injection molding machine according to the invention further includes third recording means 30 which are connected with the control device 5 via a connecting line 31 for data transmission, and wherein information recorded by the recording means 30, for example concerning the operating condition of the machine, the instantaneous energy consumption, the required or available cooling power and the like, are transmitted to the control device 5.

As seen in FIG. 1, the control device 5 is preferably integrated in the injection molding machine, for example in a space of the injection molding machine or in a cabinet integrated in the production machine.

The control device 5 also includes evaluation means 50 which evaluate the information received via a connecting lines 11, 21 and 31 from the first, second and/or third receiving means 10, 20, 30 essentially in real time and further determine the expected raw material requirements, the expected production time and/or the expected production costs of the product or similar information, such as information about the production flow and the status of the production.

The evaluation means 50 of the control device 5 also determine from the information received from the second recording means 20 via the connecting lines 21 essentially in real time the error frequency or the error probability and/or a quality value of the product. Based on the quality value and the error frequency or error probability, the parameters or the commands for controlling the material supply device 1, the plasticizing unit 2 and/or the molding device 3, for example the screw torque, the screw advance, the opening/closing time and the cooling or hardening time of the injection mold are adapted by adaptation means 51 of the control device 5 in order to cause an increase in the quality value or a decrease in the error frequency or error probability.

The control device 5 of the injection molding machine of FIG. 1 is also connected with an input or reading device 130, in particular for reading personal data which can be used for login/logout or registration and/or authentication of personnel, for example shift personnel, set-up or maintenance personnel at the injection molding machine or its control device 5. The data transmitted by the input or reading device 130 to the control device 5 are taken into consideration like any other information received by the control device 5 to determine the expected raw material requirements, the expected production time and/or the expected production costs of the product or similar information which relate to production planning and control for the product and/or a second-generation product.

The control device 5 of the injection molding machine of FIG. 1 is also connected with a data network 100 which is in turn connected with a data service terminal 120 and, on the other hand, for example with additional control devices of additional plastic processing machines or via a corresponding interface with a remote network (Wide Area Network—WAN) or with the Internet.

The control device 5 provides in the data network, preferably via data service means, data services, such as for example an application server service, an SQL server service, a Web server service and/or e-mail services, which enable communication between the data service terminal (client) 120 accessing these data services and the control device 5. In a particularly preferred embodiment, standardized data transmission protocols, for example TCP/IP, IPX, NetBEUI, AppleTalk and the like are used for transmitting the information in the data network. For example, a client can hereby view and optionally change the production parameters of the current production of the injection molding machine so as to manually affect the parameters, such as for example the screw torque, the cooling or hardening time, raw material requirements and/or the like.

In a particular preferred embodiment, these data services are used to provide information determined by the evaluation means 51, for example the expected production time, production costs and the like, but also additional information, for example offer information, delivery information, accounting information, information about personnel and the like.

The control device 5 also includes means 40 which automatically initiate, after a predetermined quantity of a product has been completed or on the day of the expected completion, via the data network and preferably via the data services, for example e-mail, FTP, SQL or via Java applets, packaging or shipping and/or the generation of shipping, packaging, accounting documents or invoices. For example, an order is sent to a shipper via e-mail to provide packaging material on the day of the expected completion of a product, and pickup of the products to be shipped is scheduled

The control device 5 further includes means 41 which inform a maintenance provider or maintenance personnel via the data network and preferably via the data services of a required maintenance, repair or retooling of the injection molding machine or the injection molding tool, and which optionally schedule a date which interferes as little as possible with the ongoing production of the injection molding machine or only briefly interrupts the operation. In particular, the means 41 are adapted to send in the event of a machine or tool defect a corresponding message to the data service terminal 120 about the defect or transmit this message via a data service to a maintenance provider or maintenance personnel with a stated priority.

The control device 5 also includes means 42 which, depending on the information received by the control device about raw material supply and consumption, automatically initiate an order from a raw material supplier for raw material, for example via e-mail, FTP, SQL or a Java applet or the like, in particular by taking into consideration delivery times and delivery schedules, which are coordinated with the production planning and control performed by the control device in such a way that, for example, the required raw material acquisition for the production of a new part is timely initiated.

In particular, the means 43 compares the raw material specifications, raw material availability and/or raw material prices from different raw material suppliers, for example via e-mail, SQL, Java or the like, and uses the result of the comparison for an automated selection of a raw material supplier from a plurality of raw material suppliers based on special raw material specifications or based on a price comparison of the raw material prices from different suppliers or their availability. The raw materials are then automatically ordered by the means 42 at the raw material supplier selected by the means 43.

The information transmitted to the control device 5 from the first, second and third recording means 10, 20, 30 and the information determined by the evaluation device 51 as well as, for example, information about operating status, errors of the plasticizing unit or of the injection mold, and also information received from the data service terminal 120 or information provided by the control device 5 via the data network or the data services are stored in memory means 140 arranged in the control device 5, optionally for later read out or further processing or evaluation. In particular, the information stored in storage device 140 can be accessed via a data service terminal 120 also via the Internet, via the data network and, for example, the SQL data service.

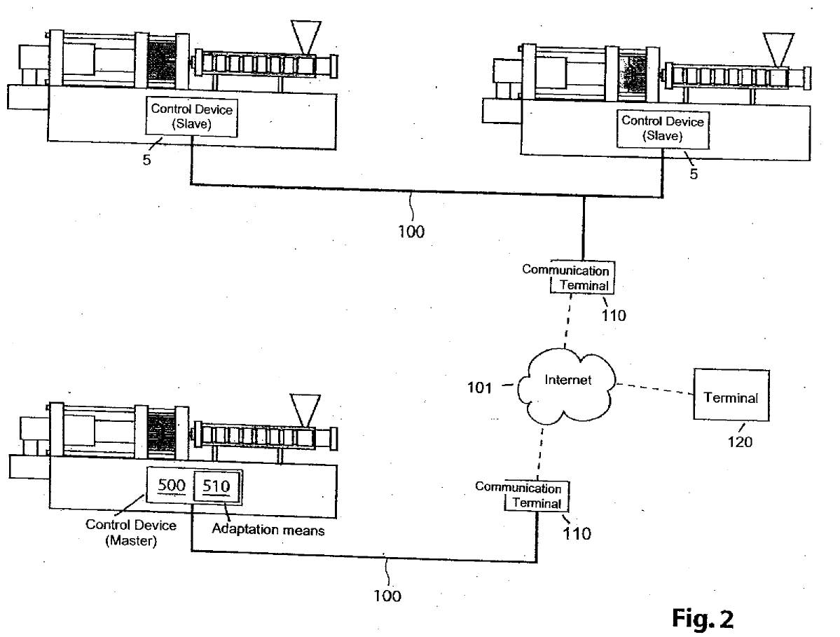

FIG. 2 shows a machine unit according to the invention wherein several injection molding machines are connected with each other via a data network 100, with the connection of the data network being provided via the Internet 101. The data network is connected with the Internet 101 via communication terminals 110, for example modems, routers, switches or the like. In a particularly preferred embodiment, the communication terminals 110 set up an encrypted connection between the communication terminals 110 via the Internet 101, so that the information transmitted between the two data network segments is protected against unauthorized access. This can be done, for example, via a VPN (Virtual Private Network) and, in particular, by using tunneling protocols, for example PPTP (Point to Point Tunneling Protocol) or L2TP (Level 2 Tunneling Protocol).

As shown in FIG. 2, the data service terminal 120 is also connected with the Internet 101 and configured so that information from the data service terminal 120 can be received from or transmitted to the data network 100 via the Internet 101. To this end, the data service terminal is also equipped with corresponding means for encrypting the data to be transmitted, for example by using a PPTP or L2TP protocol.

The control device 500 of an injection molding machine in the machine unit according to FIG. 2 is used as central control device (master), which receives from the control devices 5 of the additional devices that process plastic materials (slaves) the information recorded by their first, second and/or third recording means 10, 20, 30 as well as the information determined by the evaluation means 51. By taking into account the information received by the master itself from the first, second and/or third recording means 10, 20, 30, the master 500 determines therefrom the expected raw material requirements, the expected production costs and/or the expected production time of a predetermined quantity of a product or similar information, which is relevant for the production planning and control of the machine unit.

The machine unit of FIG. 2 therefore represents a closed system which is composed of individual plastic processing machines which are controlled by the central control device 500 and together operate as a single production machine according to the invention. Accordingly, the functions of the injection molding machine described in the description of FIG. 1 and in particular the control device 5 can therefore be applied to the central control device 500 of the machine unit of FIG. 2.

In particular, the control device 500 includes adaptation means 510 which control the parameters of the product production process of the individual slaves via the data network 100, thereby enabling production planning and control of a complex combination of production machines according to the invention with a single central control device 500 of one production machine.

In the combined machine, i.e., in the machine unit, different types of production machines can be connected with each other, so that for example a machine unit is created which is composed of injection molding machines and extrusion machines. The central control device 500 also enables the centralized control of different, simultaneously operating production processes.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. An apparatus for processing a plastic material, in particular an extrusion or injection molding machine, comprising:
at least one material supply device for supplying the plastic material to be processed as a raw material;
at least one plasticizing unit for at least one of plasticizing or homogenizing the supplied plastic material through application of at least one of mechanical and thermal energy;
at least one molding device for subjecting the plasticized or homogenized material to a forming process for forming a product, wherein the product is removed, in particular demolded, from the molding device after a predetermined cooling or hardening time or supplied to an additional machining step, or both;
at least one microprocessor-controlled control device which controls at least one of the material supply device, the plasticizing unit and the molding device;
first recording means disposed on the material supply device and connected with the control device via a connection for transmission of data, said first recording means recording and transmitting to the control device at least one of a raw material supply and a change in the raw material supply, and
second recording means disposed on the molding device or on the plasticizing unit and connected with the control device via a connection for transmission of data, said second recording means recording and transmitting to the control device at least one of process and material parameters of the plasticized or homogenized material,
wherein the control device includes evaluation means receiving data from at least one of the first and second recording means and determining from the received data essentially in real time at least one of an expected raw material requirement, an expected production time, and an expected production cost for a predetermined quantity of the product.

2. The apparatus of claim 1, wherein the evaluation means determines from the data received from the second recording means essentially in real time at least one of an error probability, an error frequency and a quality value of the product.

3. The apparatus of claim 2, wherein the control device includes adaptation means which automatically adapt control parameters controlling the material supply device, the plasticizing unit or the molding device based on the error probability, the error frequency or the quality value, in order to enhance the quality value of the product or to reduce the error frequency or error probability, or both.

4. The apparatus of claim 1, further comprising third recording means operatively connected to the control device for recording machine parameters selected from the group consisting of machine downtimes, set-up times, maintenance times, tool wear, tool service life, machine errors, tool errors, energy consumption, and coolant consumption.

5. The apparatus of claim 1, wherein the control device is connected with a data network, in particular with an intranet or with the Internet, said control device providing in the data network data services being selected from the group consisting of web services, XML server services, FTP server services, SQL server services, e-mail services, application server services, J2EE services, file server services, WebDAV server services, SMB server services, NFS server services, AFP server services

6. The apparatus of claim 5, wherein the control device operates as a terminal (client) for the data services.

7. The apparatus of claim 4, wherein the control device is connected with a data network, in particular with an intranet or with the Internet, said control device providing in the data network data services with information recorded or determined, or both, by at least one of the first, second and third recording means and the control device, said information including at least one of the expected raw material requirement, the expected production time and the expected production cost for the predetermined quantity of the product, or other information derivable therefrom about the product.

8. The apparatus of claim 1, wherein the control device comprises first means which automatically initiate at least one of packaging, shipping and preparation of invoice documents, after a predetermined quantity of the product has been completed or for a future date when a predetermined quantity of the product is expected to be completed.

9. The apparatus of claim 1, wherein the control device comprises second means which automatically initiate at least one of retooling and maintenance based on predetermined production quantities, machine operating times, or machine downtimes or based on information recorded or determined by the control device, or a combination thereof.

10. The apparatus of claim 1, wherein the control comprises third means which automatically initiate based on the information recorded or determined by the control device ordering and delivery of raw material, in particular by taking into consideration delivery times or delivery dates.

11. The apparatus of claim 10, wherein the control device comprises fourth means which determine from at least one raw material supplier raw material data selected from the group consisting of raw material specifications, raw material availability, and raw material price, and automatically select a single raw material supplier from the at least one raw material supplier.

12. The apparatus of claim 5, further comprising a terminal (client) connected to the data network and configured to access the data services of the control device via the data network for changing at least one of a parameter of a product manufacturing process, the predetermined quantity of a product, a raw material specification for a product, a minimum quality value of a product, a priority value, a target delivery date for a product, a tool maintenance interval, and a machine maintenance interval.

13. The apparatus of claim 1, wherein the control device is connected with at least one device for inputting or reading personal data to be usable for registering or authenticating personnel, in particular personnel involved in set-up or maintenance.

14. The apparatus of claim 13, wherein the input or reading device is selected from the group consisting of magnetic card reading device, chip card reading device, biometric data reading device, fingerprint reading device, handprint reading device and face recognition device.

15. The apparatus of claim 4, wherein for determining the expected production cost, the evaluation means of the control device take into account at least one of the error probability, the error frequency, the quality value, the machine downtimes, the set-up times, the maintenance times, the tool wear, the tool service life, the machine, the tool errors, the energy consumption, the coolant consumption, raw material consumption, a raw material price, the priority value or a target delivery time, and expenses for personnel.

16. The apparatus of claim 4, further comprising a storage device connected with the control device, wherein the control device or the storage device include memory means that store the data transmitted by at least one of the first, second and the third recording means or the information determined by the control device, said memory means being selected from the group consisting of hard disk memory, magnetic tape memory, flash memory, EEPROM memory (Electrically Erasable Programmable Read-Only Memory), and RAM (Random Access Memory).

17. The apparatus of claim 8, wherein the first means automatically initiate packaging, shipping or preparation of invoice documents via a data network.

18. The apparatus of claim 9, wherein the second means automatically initiate retooling or maintenance via a data network.

19. The apparatus of claim 10, wherein the third means automatically initiate ordering and delivery of raw material via a data network.

20. The apparatus of claim 11, wherein the fourth means automatically determine the raw material data via a data network.

21. A machine unit with at least two apparatuses for processing plastic materials, in particular extrusion or injection molding machines, each apparatus comprising:
at least one material supply device for supplying the plastic material to be processed as a raw material;
at least one plasticizing unit for at least one of plasticizing or homogenizing the supplied plastic material through application of at least one of mechanical and thermal energy;
at least one molding device for subjecting the plasticized or homogenized material to a forming process for forming a product, wherein the product is removed, in particular demolded, from the molding device after a predetermined cooling or hardening time or supplied to an additional machining step, or both;
at least one microprocessor-controlled control device which controls at least one of the material supply device, the plasticizing unit and the molding device;
first recording means disposed on the material supply device and connected with the control device for transmission of data, said first recording means recording and transmitting to the control device at least one of a raw material supply and a change in the raw material supply, and
second recording means disposed on the molding device or on the plasticizing unit and connected with the control device for transmission of data, said second recording means recording and transmitting to the control device at least one of process and material parameters of the plasticized or homogenized material,
wherein the control device includes evaluation means receiving data from at least one of the first and second recording means and determining from the received data essentially in real time at least one of an expected raw material requirement, an expected production time, and an expected production cost for a predetermined quantity of the product,
wherein the control devices of the at least two apparatuses are connected with each other via a data network, in particular via an intranet or via the Internet, with the control device of a first of the at least two apparatuses operating as a central control device (master) for the connected control devices (slaves) of the other apparatuses,
wherein the information recorded by at least the first and second recording means of all of the at least two apparatuses and the information recorded or determined by the control devices of the connected control devices (slaves) are transmitted to the central control device (master), and
wherein the master combines the recorded or determined information, and determines therefrom essentially in real time the expected raw material requirement, the expected production time or the expected production cost for the predetermined quantity of the product for the machine unit.

22. The machine unit according to claim 21, wherein the central control device (master) includes adaptation means which control via the data network parameters selected from the group consisting of product manufacturing process parameters, a predetermined quantity of the product, a raw material requirement for the product, a minimum quality value of the product, a tool maintenance interval, and a machine maintenance interval of the slaves or of the at least two apparatuses operatively connected with the slaves.
